(19) United States
(12) Patent Application Publication
(10) Pub. No.: US 2025/0315334 A1
(43) Pub. Date: Oct. 9, 2025

(54) ANOMALY-TARGETED DATA COLLECTION

(71) Applicant: Dell Products L.P., Round Rock, TX (US)

(72) Inventors: Darrell Christopher Stam, Hollis, NH (US); Nicolas H. Leazard, Hudson, NH (US); David C. Sydow, Merrimack, NH (US); Jeremy Denis White, Londonderry, NH (US); Matthew P. Piuze, Amherst, NH (US)

(21) Appl. No.: 18/628,407

(22) Filed: Apr. 5, 2024

(51) Int. Cl. G06F 11/00

(52) U.S. Cl. CPC G06F 11/0781; G06F 11/0709; G06F 11/0727

(57) ABSTRACT

An apparatus includes at least one processing device including a processor coupled to a memory, wherein the at least one processing device is configured to detect an anomaly from a set of specific anomalies in an information processing system and a time period of interest associated with the detected anomaly from the set of specific anomalies, and execute a data collection process that is targeted for the detected anomaly based on the time period of interest, wherein the data collection process generates a set of collected data indicative of the detected anomaly.

### FIELD

The field relates generally to information processing systems, and more particularly to data collection in such information processing systems.

### BACKGROUND

Information processing systems, such as, for example, systems including enterprise storage arrays, often include internal services to triage problems when such systems are remotely deployed at customer locations. As part of such a problem triage service, it is important to be able to gather information pertinent to the problem to be addressed. This process is called data collection. Data collection involves coalescing information, for example, indicative of system configuration, performance numbers, database entries, system logs, and various hardware connections on the system. However, in many information processing systems, the data collection process is an unfocused gathering of support information, where large amounts of unnecessary data are gathered.

### SUMMARY

Illustrative embodiments provide targeted data collection techniques that are triggered by a specific anomaly detected in an information processing system. While particularly useful in the context of enterprise storage arrays, it is to be understood that techniques described herein are not limited thereto and may thus be applied to a wide variety of information processing systems.

In one illustrative embodiment, an apparatus includes at least one processing device including a processor coupled to a memory, wherein the at least one processing device is configured to detect an anomaly from a set of specific anomalies in an information processing system and a time period of interest associated with the detected anomaly from the set of specific anomalies. The processing device is further configured to execute a data collection process that is targeted for the detected anomaly based on the time period of interest, wherein the data collection process generates a set of collected data indicative of the detected anomaly.

These and other illustrative embodiments include, without limitation, methods, apparatus, networks, systems and processor-readable storage media.

### BRIEF DESCRIPTION OF THE DRAWINGS

FIG. 1 shows an information processing system environment with anomaly-targeted data collection functionalities according to an illustrative embodiment.

FIG. 2 shows an anomaly-targeted data collection engine according to an illustrative embodiment.

FIG. 3 shows an anomaly detection process according to an illustrative embodiment.

FIG. 4 shows an anomaly detection process according to another illustrative embodiment.

FIG. 5 shows an anomaly detection process according to yet another illustrative embodiment.

FIG. 6 shows a rule-based decision tree process according to an illustrative embodiment.

FIG. 7 shows a table with attributes associated with anomaly-targeted data collections according to an illustrative embodiment.

FIG. 8 shows an example portion of an object file augmented with anomaly-identifying tag data according to an illustrative embodiment.

FIG. 9 shows an anomaly-targeted data collection methodology according to an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the terms “information processing system” and “information processing system environment” as used herein are intended to be broadly construed, so as to encompass, for example, processing systems comprising cloud computing and storage systems, as well as other types of processing systems comprising various combinations of physical and virtual processing resources. An information processing system environment may therefore include, for example, at least one data center, as well as a computing platform operatively coupled to the data center. For example, in some illustrative embodiments, an information processing system environment may include an enterprise computing platform operatively coupled to a customer data center, wherein the customer computing data center includes one or more devices (e.g., storage arrays) installed and/or supported by the enterprise. In some embodiments, for example, the enterprise computing platform and the customer data center may each individually be considered an information processing system, and thus collectively be considered an information processing system environment. In other embodiments, the enterprise computing platform and the customer data center may each individually be considered an information processing system environment.

As mentioned, in many information processing systems, e.g., systems including enterprise storage arrays, the existing data collection process is an unfocused gathering of support information, where large amounts of unnecessary data are gathered. This poses several technical issues for the computing resources (e.g., processing, storage, and network resources) of the information processing system environment.

For example, the significant size of the data collected places a burden on data storage and network resources associated with transmitting the collected data from the customer data center to the enterprise computing platform, e.g., the transfer time could be measured in hours, followed by the time to load the content into triage tools. Even in situations where the triage tools are collocated with the storage arrays for which data is being collected, there is a burden on the underlying storage resources given the amount of data needed to be stored.

Another technical issue is the timing of when the data is gathered, e.g., gathering data during real-time operations of the customer data center causes a burden on data processing resources of the data center. Likewise, similar timing issues can burden the enterprise computing platform.

Still further, the unfocused nature of the data that is being collected is a technical issue since extra processing burden is placed on the enterprise computing platform (or whichever information processing system is processing the collected data) when the platform has to parse the vast amount of unfocused data to obtain relevant data.

When a problem occurs on an enterprise storage array, it is often advisable to perform an on-demand data collection to get the most recent set of system data. However, existing on-demand data collection involves a significant amount of time, customer interaction, and support intervention to retrieve the data necessary to triage the problem. By the time the customer realizes that there is a problem and contacts the enterprise, the root cause of the issue could be missing from the data being collected. Once this large set of data is collected and transferred back to the customer support team of the enterprise, significant time and resources are consumed, further delaying the time to resolution to the issue. In addition, as mentioned above, storing this significant amount of data is not only inefficient but also incurs additional storage resources.

It is realized herein that providing technical solutions to determine when a problem occurs and what data is most needed to resolve the issue will result in many technical advantages including, but not limited to, reducing the time to resolution for customers, helping ensure proper data retention, and saving computing system resources.

Illustrative embodiments enable the above and other technical solutions and advantages by providing techniques for monitoring the health of a system and automatically performing a data collection, when the system is unhealthy, that is targeted to the specific detected anomaly. Such a targeted data collection contains a focused set of relevant data of concern when the system is in a degraded state or otherwise deemed unhealthy. As will be described in further detail herein, illustrative embodiments provide techniques for detecting specific triggers and then determining when data collection will occur, along with specific labels and associated data types that will be collected for the specific triggers.

By way of example, one or more illustrative embodiments analyze logs, check for active system alerts, scan anomaly detection engine results, and review status of system health checks to automatically create a focused (targeted) data collection that is customized to solve the one or more problems that were found. Problems can be related to software and/or hardware. Illustrative embodiments use triggers and tags to determine both the time to collect the data and the actual subset of data to gather. These tags can make it easier to identify when an anomaly occurred and why the anomaly happened.

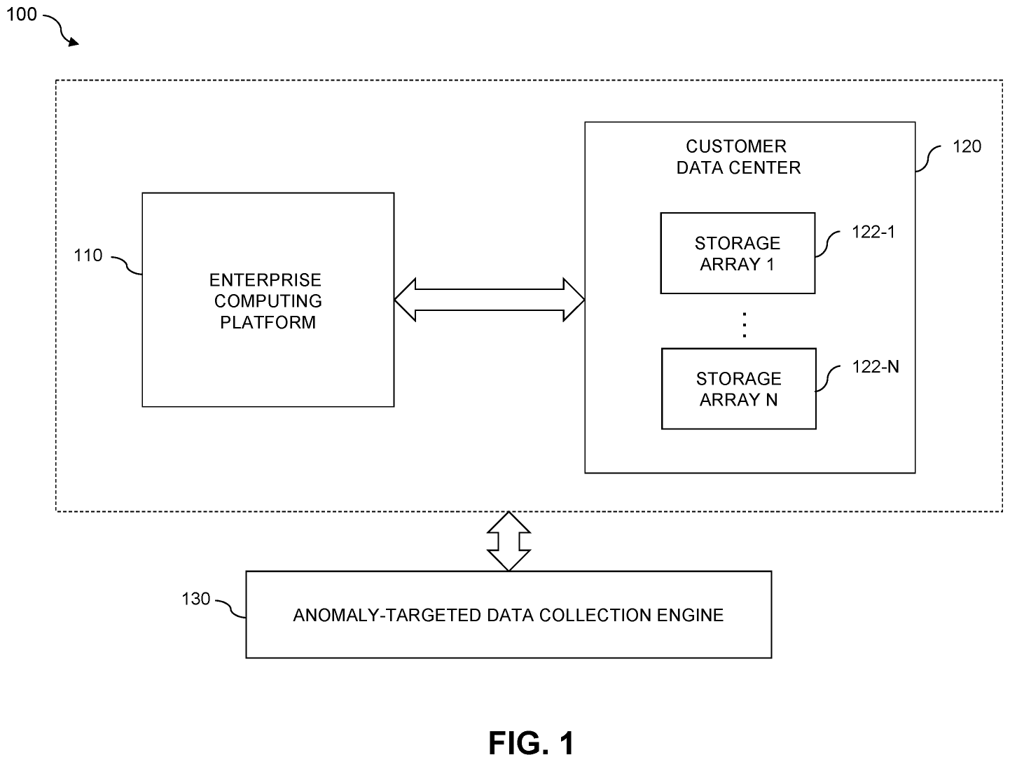

Referring initially to FIG. 1, an information processing system environment 100 is shown with anomaly-targeted data collection functionalities according to an illustrative embodiment. As shown, an enterprise computing platform 110 is operatively coupled to a customer data center 120. In some embodiments, customer data center 120 is remote from (e.g., geographically or from an access perspective) enterprise computing platform 110. Customer data center 120 includes storage arrays 122-1, . . . , 122-N (collectively referred to herein as storage arrays 122 or individually as storage array 122) which are assumed to have been installed and/or otherwise supported by the enterprise (e.g., OEM) associated with enterprise computing platform 110.

As further shown, information processing system environment 100 includes an anomaly-targeted data collection engine 130 operatively coupled to enterprise computing platform 110 and customer data center 120. Anomaly-targeted data collection engine 130 is configured to provide the anomaly-targeted data collection functionalities including, but not limited to, monitoring the health of storage arrays 122 of customer data center 120 and automatically performing a data collection, when one or more of storage arrays 122 are unhealthy, that is targeted to the specific detected anomaly, as will be described in further detail below.

Note that, for the sake of simplicity of illustration, anomaly-targeted data collection engine 130 is depicted in FIG. 1 as being outside of enterprise computing platform 110 and customer data center 120. For example, in some embodiments, anomaly-targeted data collection engine 130 can be implemented in one or more computing platforms separate from enterprise computing platform 110 and customer data center 120. In other embodiments, anomaly-targeted data collection engine 130 can be implemented within enterprise computing platform 110, while in further embodiments, anomaly-targeted data collection engine 130 can be implemented within customer data center 120. Still further, in additional embodiments, parts of anomaly-targeted data collection engine 130 can be implemented in two or more of enterprise computing platform 110, customer data center 120, and the one or more separate computing platforms separate from enterprise computing platform 110 and customer data center 120.

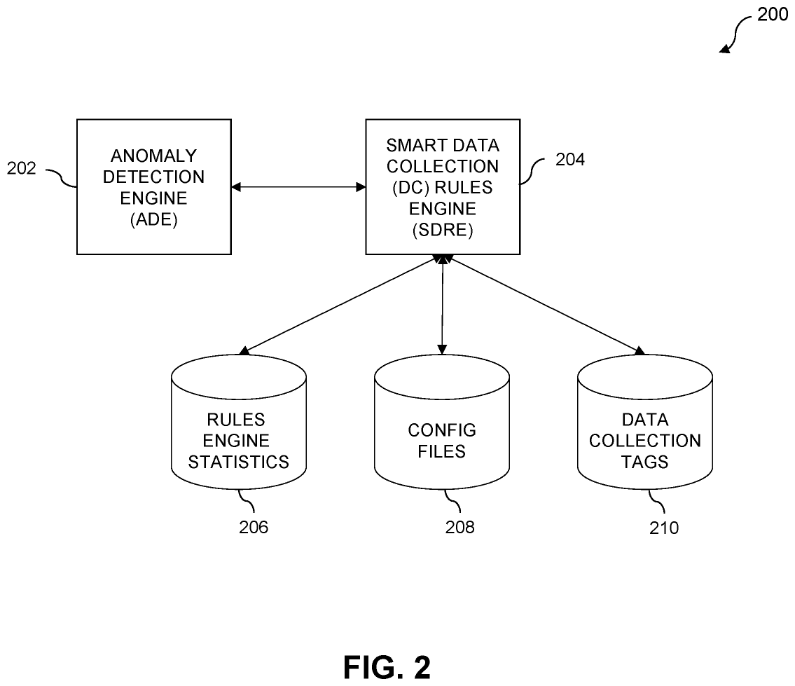

Referring now to FIG. 2, an anomaly-targeted data collection engine 200 is shown according to an illustrative embodiment. By way of example, anomaly-targeted data collection engine 200 can be considered an illustrative embodiment of anomaly-targeted data collection engine 130 of FIG. 1.

As shown in FIG. 2, anomaly-targeted data collection engine 200 includes a multi-tier architecture including an anomaly detection engine (ADE) 202 and a smart data collection (DC) rules engine (SDRE) 204 operatively coupled thereto. Also, operatively coupled to SDRE 204 are a rules engine statistics store 206, a configuration (config) files store 208, and a data collection tags store 210, as will be described in further detail below. ADE 202 and SDRE 204 operate collectively to correlate specific anomalies identified against system health for the purpose of deciding if a data collection process should be started and, if so, what attributes the data collection process should have.

In some embodiments, ADE 202 is configured to detect and report anomalies that may then be acted upon by SDRE 204. In addition, ADE 202 provides SDRE 204 with a specific time period during which data should be collected. In some embodiments, ADE 202 is configured to detect the following specific anomalies: (i) system reboots; (ii) operating system (OS) kernel panics; and (iii) anomalous user input/output (I/O) patterns. All or a subset of the above-mentioned specific anomalies, and/or other specific anomalies, can be detected by ADE 202 in other embodiments.

As illustratively used herein, the term system reboot refers to the occurrence of a process of restarting one or more of storage arrays 122 to, for example, refresh the OS and clear temporary data. Further, as illustratively used herein, the term a kernel panic refers to one or more actions taken by an OS kernel running on one or more of storage arrays 122 upon the occurrence of an internal fatal (unrecoverable) error or an internal non-fatal (recoverable) error that could still result in significant data loss. Still further, as illustratively used herein, the term user I/O patterns refer to sets of reads and/or writes of data stored in one or more of storage arrays 122 by one or more applications executing on host devices of a customer data center 120. Thus, anomalous user I/O patterns would be data read/write requests that are not typical or that are otherwise not expected by the one or more storage arrays 122. The above illustrative definitions of terms describing specific anomalies that ADE 202 is configured to detect can vary in alternative embodiments.

In some embodiments, ADE 202 can detect: (i) system reboots via events and/or alerts received from the information processing system being monitored (e.g. storage arrays 122 of customer data center 120 in FIG. 1); (ii) OS kernel panics via core dump files visible to the OS; and (iii) anomalous user I/O patterns by statistical analysis including, but not limited to, machine learning models and algorithms. ADE 202 is also configured to determine how long system data should be collected both before and after one of the specific anomalies are detected.

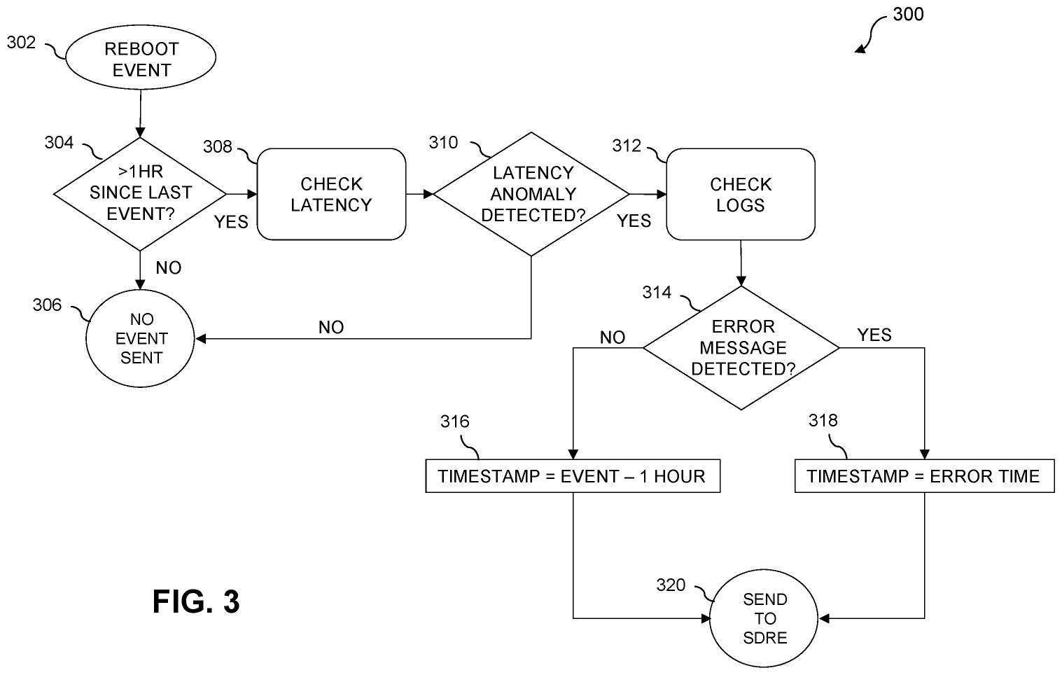

FIG. 3 shows an anomaly detection process 300 according to an illustrative embodiment. More particularly, anomaly detection process 300 is a process executed by ADE 202 to detect a system reboot anomaly. For example, when a system reboot event/alert is triggered in one or more storage arrays 122, ADE 202 determines whether or not the system reboot anomaly should be sent to SDRE 204 and, if so, specifies a time period (e.g., begin and end) for targeted data collection.

As shown in FIG. 3, step 302 receives an alert of the occurrence of a system reboot event and records the time of receipt of the alert. It is assumed that the time of the alert and the time of the event are the same (e.g., the alert is instantaneous or substantially contemporaneous with the event). However, when determined to be significantly different, the time of the event can be recorded in place of the time of receipt of the alert.

Step 304 then determines whether more than a given time period, e.g., in this scenario, one hour, has elapsed since the last system boot event. When step 304 returns a negative result (e.g., more than one hour has not elapsed since the last system boot event), then the system reboot event is not sent to SDRE 204 and anomaly detection process 300 ends at step 306.

However, when step 304 returns an affirmative result (e.g., more than one hour has elapsed since the last system boot event), then step 308 performs a latency check and step 310 determines whether any anomalous user latency has been detected as a result of the latency check performed in step 308. When step 310 returns a negative result (e.g., no anomalous user latency has been detected), then the system reboot event is not sent to SDRE 204 and anomaly detection process 300 ends at step 306.

However, when step 310 returns an affirmative result (e.g., anomalous user latency has been detected), then step 312 checks system logs (e.g., associated with storage arrays 122) and step 314 determines whether any message in the system logs has been tagged as an error message. When no error message is detected in step 314, step 316 sets and stores a timestamp to be sent to SDRE 204 as the time of the system reboot alert (time recorded when the system reboot alert was received in step 302) with an offset of one hour prior to the time of the system reboot alert. When an error message is detected in step 314, step 318 sets and stores a timestamp to be sent to SDRE 204 as the offset of the error message from the system reboot alert. Step 320 sends the timestamp computed in step 316 or 318 to SDRE 204.

Accordingly, in summary, when executing anomaly detection process 300 as described above, ADE 202 scans through system logs one hour prior to the time of a system reboot alert. When a message tagged with an error tag (or more severe tag) is found, the offset of the error message from the system reboot alert is stored. If no error message is found, a timestamp with an offset of one hour prior to the reboot alert is stored. Also, as described above, when ADE 202 determines that anomalous user latency was reported, then a reboot anomaly event is sent to SDRE 204 along with the stored timestamp. ADE 202 will not send anomalous triggers to SDRE 204 unless the system has not experienced a reboot alert/event for at least one hour, in order to prevent rolling reboots from triggering multiple data collections.

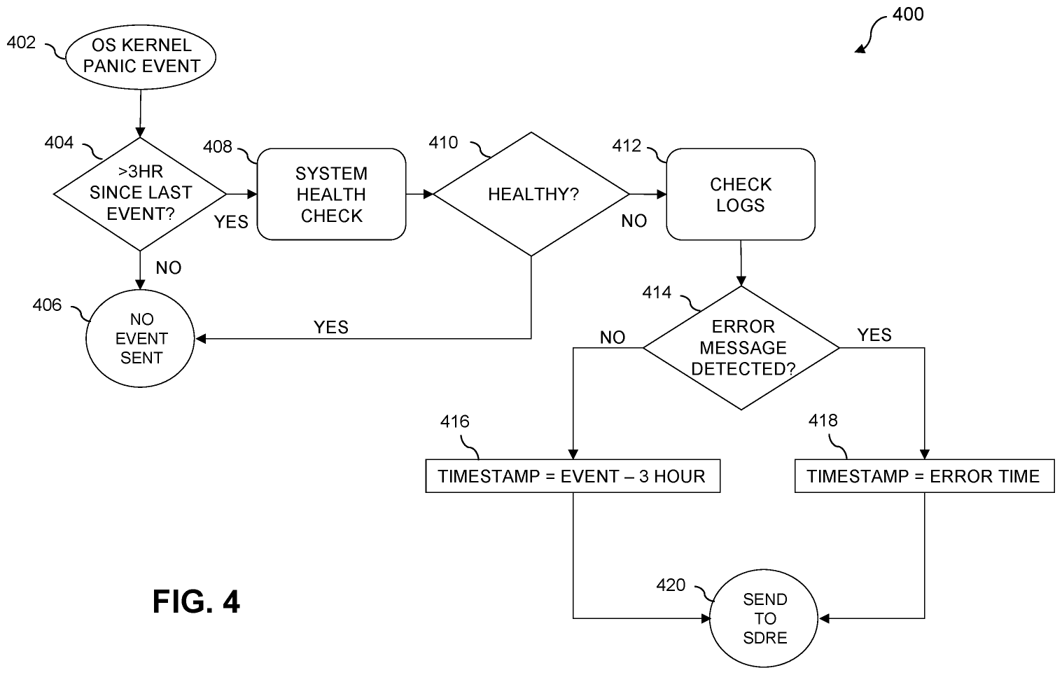

FIG. 4 shows an anomaly detection process 400 according to an illustrative embodiment. More particularly, anomaly detection process 400 is a process executed by ADE 202 to detect an OS kernel panic anomaly. For example, when an OS kernel panic event/alert is triggered in one or more storage arrays 122, ADE 202 determines whether or not the OS kernel panic anomaly should be sent to SDRE 204 and, if so, specifies a time period (e.g., begin and end) for targeted data collection. Note that ADE 202 compares the OS kernel panic alert to a list of prior events recorded by ADE 202 to determine if it is time for an OS kernel panic data collection to be triggered. If the last OS kernel panic occurred outside a three-hour window, ADE 202 sends this event to SDRE 204.

More particularly, as shown in FIG. 4, step 402 receives an alert of the occurrence of a system reboot event and records the time of receipt of the alert. It is assumed that the time of the alert and the time of the event are the same (e.g., the alert is instantaneous or substantially contemporaneous with the event). However, when determined to be significantly different, the time of the event can be recorded in place of the time of receipt of the alert.

Step 404 then determines whether more than a given time period, e.g., in this scenario, three hours, has elapsed since the last OS kernel panic event. When step 404 returns a negative result (e.g., more than three hours have not elapsed since the last OS kernel panic event), then the OS kernel panic event is not sent to SDRE 204 and anomaly detection process 400 ends at step 406.

However, when step 404 returns an affirmative result (e.g., more than three hours have elapsed since the last OS kernel panic event), then step 408 performs a system heath check (e.g., initiates a health check routine built into each storage array 122) and step 410 determines whether the system is healthy or not based on the health check results. When step 410 returns an affirmative result (e.g., system healthy), then the OS kernel panic event is not sent to SDRE 204 and anomaly detection process 400 ends at step 406.

However, when step 410 returns a negative result (e.g., system not healthy), then step 412 checks system logs (e.g., associated with storage arrays 122) and step 414 determines whether any message in the system logs has been tagged as an error message. When no error message is detected in step 414, step 416 sets and stores a timestamp to be sent to SDRE 204 as the time of the OS kernel panic alert (time recorded when the OS kernel panic alert was received in step 402) with an offset of three hours prior to the time of the OS kernel panic alert. When an error message is detected in step 414, step 418 sets and stores a timestamp to be sent to SDRE 204 as the offset of the error message from the OS kernel panic alert. Step 420 sends the timestamp computed in step 416 or 418 to SDRE 204.

Accordingly, in summary, when executing anomaly detection process 400 as described above, ADE 202 scans through system logs three hours prior to the time of an OS kernel reboot alert. When a message tagged with an error tag (or more severe tag) is found, the offset of the error message from the system reboot alert is stored. In other words, when there are any logs associated with the OS kernel panic event, with the severity of error or greater, the timestamp of that log message is used as the timestamp offset sent to SDRE 204. If no error message is found, a timestamp with an offset of three hours prior to the OS kernel panic alert is stored. Also, as described above, ADE 202 checks (e.g., via a system health check) whether the system is unhealthy between the stored timestamp and the time of the OS kernel panic alert. When the system is unhealthy, then an OS kernel panic event will be sent to SDRE 204 along with the stored timestamp. ADE 202 will only send new OS kernel panic triggers to SDRE 204 every three hours. This condition is intended to prevent rolling panics from triggering multiple data collections.

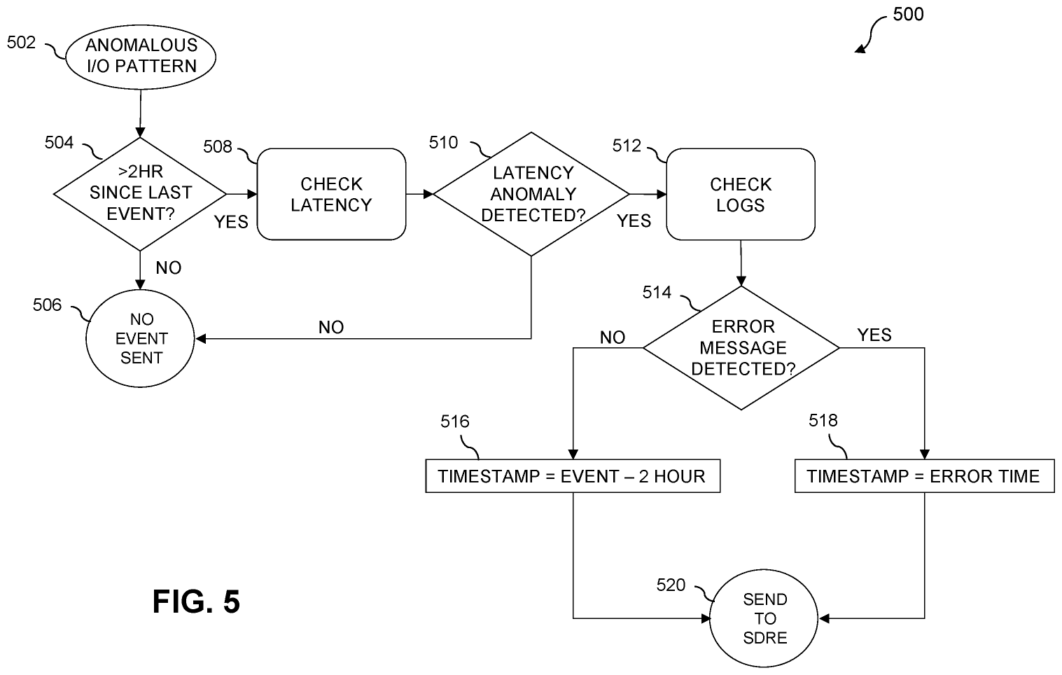

FIG. 5 shows an anomaly detection process 500 according to an illustrative embodiment. More particularly, anomaly detection process 500 is a process executed by ADE 202 to detect a user I/O pattern anomaly. For example, when an anomalous user I/O pattern event/alert is triggered in one or more storage arrays 122, ADE 202 determines whether or not the user I/O pattern anomaly should be sent to SDRE 204 and, if so, specifies a time period (e.g., begin and end) for targeted data collection. Note that ADE 202 detects and processes anomalous user I/O patterns such as, but not limited to, latency, throughput, or bandwidth degradation. The most recent user I/O anomalies are recorded by ADE 202 in order to compare and not trigger simultaneous data collections for the same issue. When the last anomaly occurred in a time span longer than two hours, then this event is sent to SDRE 204 to be processed.

As shown in FIG. 5, step 502 receives an alert of the occurrence of an anomalous user I/O pattern event and records the time of receipt of the alert. It is assumed that the time of the alert and the time of the event are the same (e.g., the alert is instantaneous or substantially contemporaneous with the event). However, when determined to be significantly different, the time of the event can be recorded in place of the time of receipt of the alert.

Step 504 then determines whether more than a given time period, e.g., in this scenario, two hours, has elapsed since the last anomalous user I/O pattern event. When step 504 returns a negative result (e.g., more than two hours have not elapsed since the last anomalous user I/O pattern event), then the anomalous user I/O pattern event is not sent to SDRE 204 and anomaly detection process 500 ends at step 506.

However, when step 504 returns an affirmative result (e.g., more than two hours have elapsed since the last anomalous user I/O pattern event), then step 508 performs a latency check and step 510 determines whether any anomalous user latency has been detected as a result of the latency check performed in step 508. When step 510 returns a negative result (e.g., no anomalous user latency has been detected), then the anomalous user I/O pattern event is not sent to SDRE 204 and anomaly detection process 500 ends at step 506.

However, when step 510 returns an affirmative result (e.g., anomalous user latency has been detected), then step 512 checks system logs (e.g., associated with storage arrays 122) and step 514 determines whether any message in the system logs has been tagged as an error message. When no error message is detected in step 514, step 516 sets and stores a timestamp to be sent to SDRE 204 as the time of the anomalous user I/O pattern alert (time recorded when the anomalous user I/O pattern alert was received in step 502) with an offset of two hours prior to the time of the anomalous user I/O pattern alert. When an error message is detected in step 514, step 518 sets and stores a timestamp to be sent to SDRE 204 as the offset of the error message from the anomalous user I/O pattern alert. Step 520 sends the timestamp computed in step 516 or 518 to SDRE 204.

Accordingly, in summary, when executing anomaly detection process 500 as described above, ADE 202 scans through system logs two hours prior to the time of an anomalous user I/O pattern alert. When a message tagged with an error tag (or more severe tag) is found, the offset of the error message from the anomalous user I/O pattern alert is stored. If no error message is found, a timestamp with an offset of two hours prior to the anomalous user I/O pattern alert is stored. In other words, when any messages with the severity of error or greater is found, the timestamp offset of the error message is used to trigger SDRE 204. Otherwise, the timestamp with an offset of two hours prior to the event/alert is used. Also, as described above, when ADE 202 determines that anomalous user latency was reported, then an anomalous user I/O pattern event is sent to SDRE 204 along with the stored timestamp. ADE 202 will not send anomalous user I/O pattern triggers to SDRE 204 unless the system has not experienced an anomalous user I/O pattern alert/event for at least two hours, in order to prevent rolling reboots from triggering multiple data collections.

Accordingly, SDRE 204 receives notification of specific anomalous events detected by ADE 202 as illustratively described above in the context of anomaly detection processes 300, 400, and 500. In response thereto, SDRE 204 is configured to use a system health score to determine if a data collection should be performed, determine what data should be collected based on the specific anomaly type, initiate a data collection process with the timestamps specified by ADE 202, and label collected data with labels appropriate to the anomaly detected.

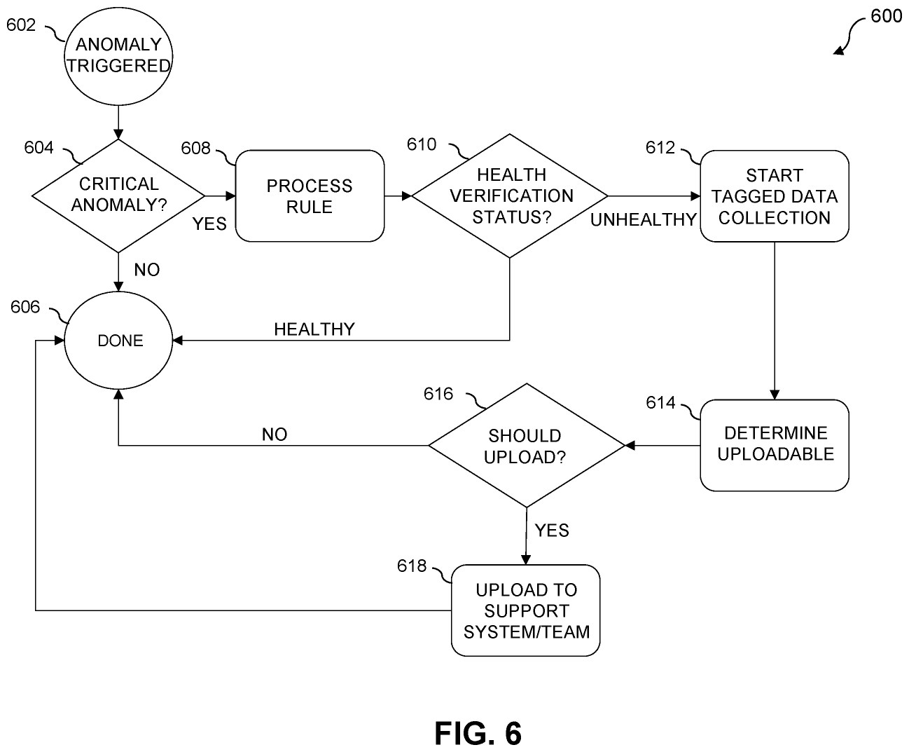

FIG. 6 shows a rule-based decision tree process 600 that can be implemented by SDRE 204 according to an illustrative embodiment. More particularly, rule-based decision tree process 600 outlines steps that SDRE 204 takes to determine if a system data collection should be initiated based on the output of ADE 202. As shown in FIG. 6, step 602 receives an anomaly event from ADE 202. Receipt of the anomaly triggers step 604 to confirm that the anomaly is a critical anomaly. It is assumed that SDRE 204 is configured to consider any one of a system reboot event detected and sent by ADE 202 in anomaly detection process 300, an OS kernel panic event detected and sent by ADE 202 in anomaly detection process 400, and a user I/O pattern event detected and sent by ADE 202 in anomaly detection process 500, as a critical anomaly in step 604. If no such critical anomaly is identified in step 604, rule-based decision tree process 600 ends at step 606.

Assuming the received anomaly event is deemed critical, step 608 applies (processes) a rule from a pre-established set of rules to determine whether or not a data collection process should still go forward. In some embodiments, such pre-established set of rules can be derived from well-established criteria indicative of healthy systems, e.g., defined system information such as logs, alerts, and health scores. Based on the particular health criteria applied in step 608, step 610 functions as a verification layer and determines whether the system is healthy or unhealthy (e.g., verifying any system health determination made by ADE 202). If healthy, then rule-based decision tree process 600 ends at step 606.

However, if deemed unhealthy in step 610, tagged or labeled data collection is initiated in step 612 and executed to obtain data for the time period specified by the timestamp received from ADE 202. As will be further described below, data collected by SDRE 204 is tagged or labeled with the specific anomaly for which the data collection process is targeted. Based on the tagged data, step 614 determines the data set that will be uploaded to a support system or team, e.g., enterprise computing platform 110. After an affirmative final upload check in step 616, the data is uploaded to the support system/team in step 618 and rule-based decision tree process 600 ends at step 606. However, if step 616 indicates that the data should not be uploaded (e.g., administrative override, support system/team is not ready for data upload, etc.), then the upload does not occur and rule-based decision tree process 600 ends at step 606.

By way of example, assume SDRE 204 is called by ADE 202 with an OS kernel panic system reboot message. SDRE 204 creates a new data collection with the following data: (i) the results of a system health check; (ii) three hours of logs and event/alerts from the system until thirty minutes after the given timestamp; and (iii) the kernel panic details including pertinent data path, platform, and system level commands involved. The resulting data collection is then tagged with the tag Kernel_Panic. This data enables a support system/team to find a root cause for the kernel panic.

Similarly, when ADE 202 determines that a system reboot anomaly was caused by a user-initiated action, SDRE 204 creates a new data collection using the tag User_Initiated_Reboot which can, for example, contain thirty minutes of logs prior to the detected reboot as well as all of the events/alerts that occurred in the same time frame.

Still further, when an I/O anomaly is detected in by ADE 202, SDRE 204 creates a new data collection containing the tag I/O_Performance which can, for example, contain two hours of logs prior to the anomaly being detected as well as two hours of logs after for a total of four hours of logs collected. All of the events and alerts in the system for the given time frame are collected as well as the results of a new system health check.

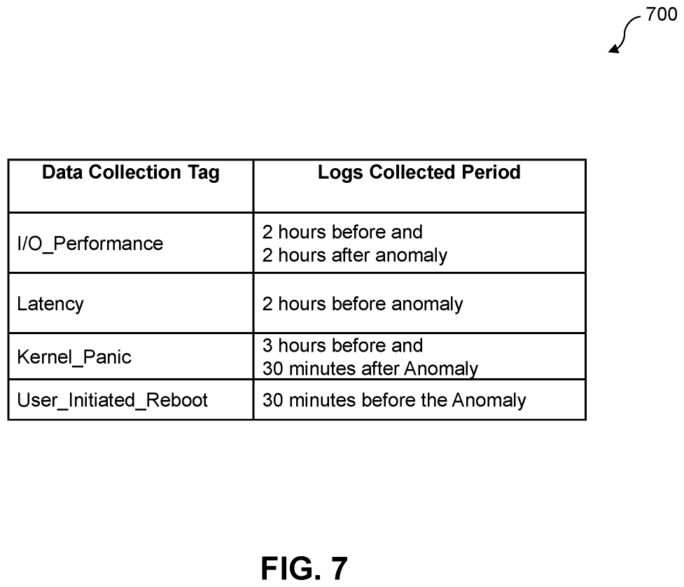

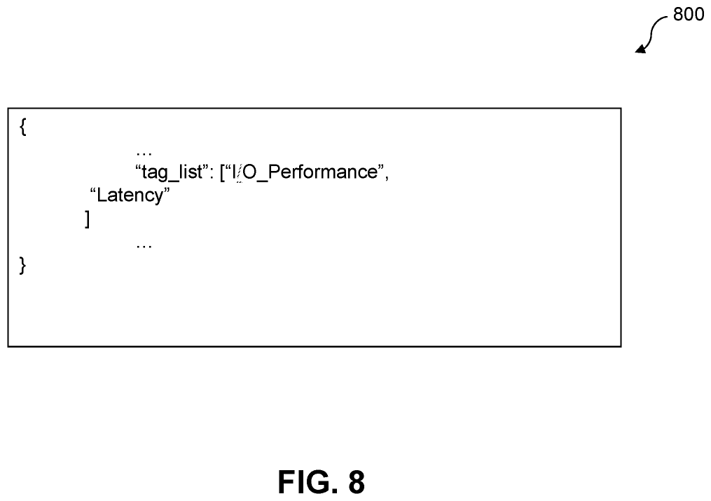

By way of example only, FIG. 7 shows a table 700 with attributes associated with anomaly-targeted data collections according to an illustrative embodiment. FIG. 8 shows an example portion of an object file 800 augmented with anomaly-identifying tag/label data consistent with a portion of table 700 of FIG. 7.

Referring back to FIG. 2, recall that SDRE 204 is operatively coupled to rules engine statistics store 206, configuration files store 208, and data collection tags store 210. It is to be understood that, in some embodiments, results and other data associated with the execution of rule-based decision tree process 600 can be stored in rules engine statistics store 206, while anomaly-identifying tag/label data can be stored in data collection tags store 210. Further, in some embodiments, configuration files store 208 can store system configuration data about the information processing system that is the subject of the monitoring and data collection, e.g., customer data center 120 including storage arrays 122.

Advantageously, the size of the data collections generated in accordance with anomaly-targeted data collection processes according to illustrative embodiments are substantially smaller than data collections associated with existing data collection processes, making it easier to parse and store in the enterprise backend. For example, 10 Gigabytes (GB) of data may be collected by an existing data collection process while anomaly-targeted data collection according to one or more illustrative embodiments can be a fraction of the 10 GB data set, e.g., 300-500 Megabytes (MB). Still further, given the smaller data set size, anomaly-targeted data collection can occur in faster time than existing data collections, e.g., 5-10 minutes for the former versus 20-60 minutes for the latter.

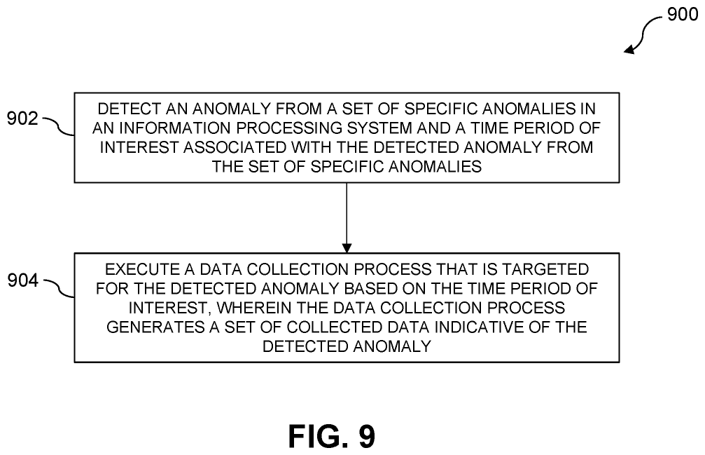

FIG. 9 shows an anomaly-targeted data collection methodology (e.g., a methodology 900) according to an illustrative embodiment. As shown in methodology 900, step 902 detects an anomaly from a set of specific anomalies in an information processing system and a time period of interest associated with the detected anomaly from the set of specific anomalies. Step 904 executes a data collection process that is targeted for the detected anomaly based on the time period of interest, wherein the data collection process generates a set of collected data indicative of the detected anomaly.

In some embodiments, an anomaly-targeted data collection methodology can label the set of collected data with a tag indicative of the detected anomaly.

In some embodiments, an anomaly-targeted data collection methodology can make the set of collected data available for further analytic processing. For example, making the set of collected data available for further analytic processing can further include sending the set of collected data to another information processing system to enable further analytic processing therein.

In some embodiments, the set of specific anomalies includes a reboot event of at least a portion of the information processing system.

In some embodiments, the set of specific anomalies includes an operating system kernel panic event in at least a portion of the information processing system.

In some embodiments, the set of specific anomalies includes an input-output pattern in at least a portion of the information processing system.

In some embodiments, the anomaly detection can be performed by an anomaly detection engine and the data collection process execution can be performed by a rule-based decision tree engine responsive to the anomaly detection engine.

In some embodiments, an anomaly-targeted data collection methodology can compute the time period of interest based on a time instance that the anomaly occurred or caused an alert.

In some embodiments, an anomaly-targeted data collection methodology can compute the time period of interest based on a predetermined time offset with respect to the time instance that the anomaly occurred or caused an alert.

In some embodiments, an anomaly-targeted data collection methodology can compute the time period of interest based on a time instance associated with an error message relevant to the detected anomaly found in a log of the information processing system.

In some embodiments, the set of collected data indicative of the detected anomaly includes results of a health check executed for the information processing system, log data from for the information processing system for a time duration relative to the time period of interest, and details relevant to the detected anomaly.

Advantageously, illustrative embodiments provide technical solutions that distinguish between specific faults and proactively collect smaller amounts of labeled data for non-critical faults. There is significant value in tracking these faults as they are often early indicators of more critical issues, and proactively addressing them can prevent critical failures.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

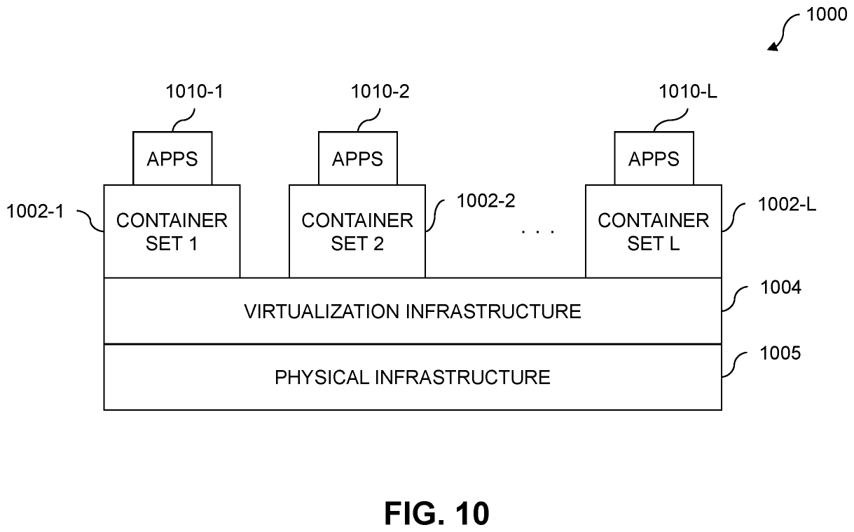

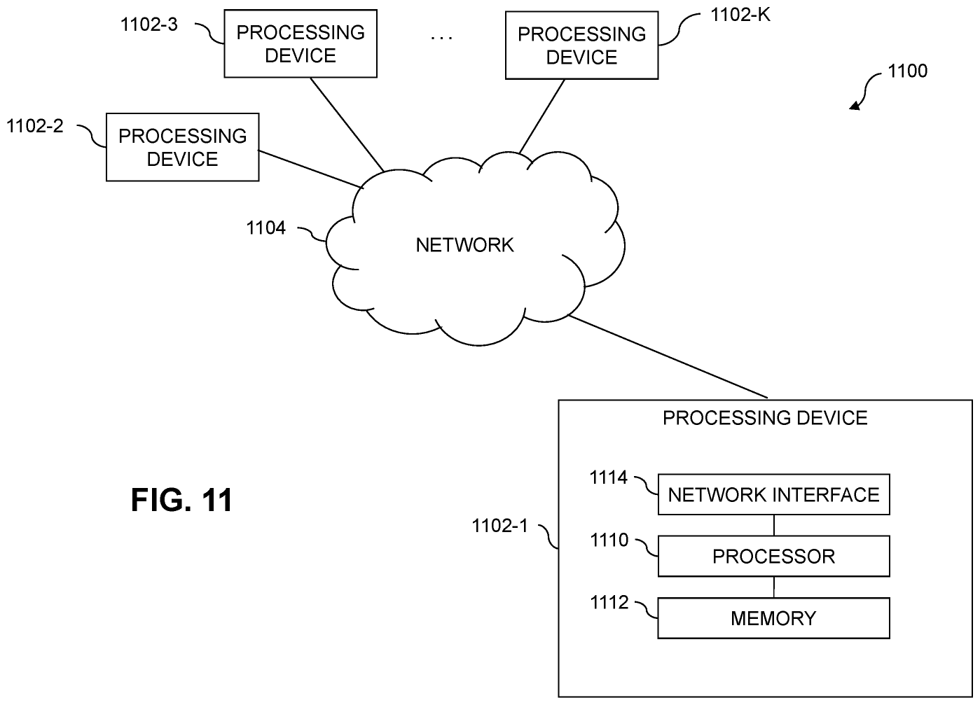

Illustrative embodiments of processing platforms utilized to implement anomaly-targeted data collection functionalities will now be described in greater detail with reference to FIGS. 10 and 11. Although described in the context of information processing system environment 100, these platforms may also be used to implement at least portions of other information processing systems and environments in other embodiments.

FIG. 10 shows an example processing platform comprising cloud infrastructure 1000. The cloud infrastructure 1000 includes a combination of physical and virtual processing resources that may be utilized to implement at least a portion of the information processing system environment 100 in FIG. 1. The cloud infrastructure 1000 includes multiple virtual machines (VMs) and/or container sets 1002-1, 1002-2, . . . 1002-L implemented using virtualization infrastructure 1004. The virtualization infrastructure 1004 runs on physical infrastructure 1005, and illustratively includes one or more hypervisors and/or operating system level virtualization infrastructure. The operating system level virtualization infrastructure illustratively includes kernel control groups of a Linux operating system or other type of operating system.

The cloud infrastructure 1000 further includes sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may include respective VMs, respective sets of one or more containers, or respective sets of one or more containers running in VMs.

In some implementations of the FIG. 10 embodiment, the VMs/container sets 1002 include respective VMs implemented using virtualization infrastructure 1004 that includes at least one hypervisor. A hypervisor platform may be used to implement a hypervisor within the virtualization infrastructure 1004, where the hypervisor platform has an associated virtual infrastructure management system. The underlying physical machines may include one or more distributed processing platforms that include one or more storage systems.

In other implementations of the FIG. 10 embodiment, the VMs/container sets 1002 include respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environment 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment includes at least a portion of information processing system environment 100 and includes a plurality of processing devices, denoted 1102-1, 1102-2, 1102-3, . . . 1102-K, which communicate with one another over a network 1104.

The network 1104 may include any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 includes a processor 1110 coupled to a memory 1112.

The processor 1110 may include a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1112 may include random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may include, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may include conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and information processing system environment 100 may include additional or alternative processing platforms, as well as numerous distinct processing platforms in any combination, with each such platform comprising one or more computers, servers, storage devices or other processing devices.

For example, other processing platforms used to implement illustrative embodiments can include converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionalities described herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, chassis configurations, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory, the at least one processing device being configured to:
detect an anomaly from a set of specific anomalies in an information processing system and a time period of interest associated with the detected anomaly from the set of specific anomalies; and
execute a data collection process that is targeted for the detected anomaly based on the time period of interest, wherein the data collection process generates a set of collected data indicative of the detected anomaly.

2. The apparatus of claim 1, wherein the at least one processing device is further configured to label the set of collected data with a tag indicative of the detected anomaly.

3. The apparatus of claim 1, wherein the at least one processing device is further configured to make the set of collected data available for further analytic processing.

4. The apparatus of claim 3, wherein making the set of collected data available for further analytic processing further comprises sending the set of collected data to another information processing system to enable further analytic processing therein.

5. The apparatus of claim 1, wherein the set of specific anomalies comprises a reboot event of at least a portion of the information processing system.

6. The apparatus of claim 1, wherein the set of specific anomalies comprises an operating system kernel panic event in at least a portion of the information processing system.

7. The apparatus of claim 1, wherein the set of specific anomalies comprises an input-output pattern in at least a portion of the information processing system.

8. The apparatus of claim 1, wherein the anomaly detection is performed by an anomaly detection engine and the data collection process execution is performed by a rule-based decision tree engine responsive to the anomaly detection engine.

9. The apparatus of claim 1, wherein the at least one processing device is further configured to compute the time period of interest based on a time instance that the anomaly occurred or caused an alert.

10. The apparatus of claim 9, wherein the at least one processing device is further configured to compute the time period of interest based on a predetermined time offset with respect to the time instance that the anomaly occurred or caused an alert.

11. The apparatus of claim 1, wherein the at least one processing device is further configured to compute the time period of interest based on a time instance associated with an error message relevant to the detected anomaly found in a log of the information processing system.

12. The apparatus of claim 1, wherein the set of collected data indicative of the detected anomaly comprises results of a health check executed for the information processing system, log data from for the information processing system for a time duration relative to the time period of interest, and details relevant to the detected anomaly.

13. A computer program product comprising a non-transitory processor-readable storage medium having stored therein program code of one or more software programs, wherein the program code when executed by at least one processing device causes the at least one processing device to:
detect an anomaly from a set of specific anomalies in an information processing system and a time period of interest associated with the detected anomaly from the set of specific anomalies; and
execute a data collection process that is targeted for the detected anomaly based on the time period of interest, wherein the data collection process generates a set of collected data indicative of the detected anomaly.

14. The computer program product of claim 13, wherein the program code when executed by at least one processing device further causes the at least one processing device to label the set of collected data with a tag indicative of the detected anomaly.

15. The computer program product of claim 13, wherein the program code when executed by at least one processing device further causes the at least one processing device to make the set of collected data available for further analytic processing.

16. The computer program product of claim 13, wherein the set of specific anomalies comprises a reboot event of at least a portion of the information processing system.

17. The computer program product of claim 13, wherein the set of specific anomalies comprises an operating system kernel panic event in at least a portion of the information processing system.

18. The computer program product of claim 13, wherein the set of specific anomalies comprises an input-output pattern in at least a portion of the information processing system.

19. The computer program product of claim 13, wherein the anomaly detection is performable by an anomaly detection engine and the data collection process execution is performable by a rule-based decision tree engine responsive to the anomaly detection engine.

20. A method comprising:
detecting an anomaly from a set of specific anomalies in an information processing system and a time period of interest associated with the detected anomaly from the set of specific anomalies; and
executing a data collection process that is targeted for the detected anomaly based on the time period of interest, wherein the data collection process generates a set of collected data indicative of the detected anomaly;
wherein the method is performed by at least one processing device comprising a processor coupled to a memory.
